(19) United States
(12) Patent Application Publication
(10) Pub. No.: US 2018/0204235 A1
(43) Pub. Date: Jul. 19, 2018

(54) METHODS AND SYSTEMS FOR EVALUATION AND EXECUTION OF A CONTROL STRATEGY ALGORITHM

(71) Applicant: MASTERCARD INTERNATIONAL INCORPORATED, Purchase, NY (US)

(72) Inventors: Briana WHELAN, Palo Alto, CA (US); Alexander Smith, Arlington, VA (US); Adam BEATON, Arlington, VA (US); Robert ALEXANDER, II, Washington, DC (US); Elizabeth LIANG, Bellevue, WA (US); Sean WALSH, Arlington, VA (US); Dennis TING, Arlington, VA (US)

(21) Appl. No.: 15/410,652

(22) Filed: Jan. 19, 2017

(51) Int. Cl. G06Q 30/02

(52) U.S. Cl. CPC G06Q 30/0207; G06Q 30/0242

(57) ABSTRACT

Disclosed herein are systems and methods that automatically identify instances where a site of a business merchant being analyzed for a test event is involved in another test event affecting a similar category of item that is being analyzed during a same time frame. The algorithm executed to automatically identify concurring events occurring at the same site calculates each event's date range, marks events as overlapping based on date range and primary category of items affected, and then determines concurring items in concurring events. The concurring events identified are accounted for in forecasting a lift over a baseline forecast in response to a promotion to estimate the effects of each promotion independently.

### TECHNICAL FIELD

This application relates generally to adjusting and executing control strategy algorithms.

### BACKGROUND

In the product and service industries, businesses purchase products from one or more vendors and sell the purchased products to consumers. Businesses may attract consumers to purchase particular products by offering various promotions. For instance, businesses often execute a number of promotional activities such as coupons, temporary price reductions, etc. to help increase demand and sales volume for the promoted product.

As the businesses are estimated to spend millions of dollars annually on promotional activity and advertising, businesses typically evaluate the financial success of specific business strategies and practices, and to assist them businesses rely on models that represent general and/or specific business patterns. The evaluation of the promotions is generally done to help the businesses understand if any action (e.g., promotion, price change, marketing) is effective at driving incremental profit. The task typically involves balancing a set of opposing factors, such as trying to attain a profitable and balanced mix of prices that will generate revenue and profit while temporarily reducing products prices during a promotion. Therefore, the employment of the tools for the evaluation of the promotions is useful to measure the effectiveness of the promotional activities offered by the businesses. For example, the businesses may analyze the effectiveness of the special promotional activity by comparing the sales data for a period surrounding the promotion with the historical baselines sales data.

Conventional methods draw conclusions from merely evaluating the differences between promotional sales data and baseline sales data, and have been typically misleading and potentially unsuccessful for business strategists. This is because typically many factors contribute to sales, however such factors are often overlooked while doing the evaluation. For example, at one or more store locations of a business merchant, two or more promotions may be going at the same time for a same product or on a same category of products. In other words, overlapping events such as simultaneous promotions may be occurring during a particular time period, which means that more than one promotion event is active. For instance, an item may be placed in a clearance sale front of the store, when an item is also advertised in a flyer, or when an item is discounted by e-mail offers. The problem becomes harder when multiple promotion events are active at the same time where each promotion event may lead to boost sales, or increase traffic in stores, or clear merchandise, or all of the above. The currently available evaluation systems does not take into account that all promotions may have had an effect on the sales of a particular product or item during the promotion period while evaluating the effectiveness of a single promotion offer on the particular item at the one or more store locations during the promotion period.

In another example, when the conventional evaluation systems evaluate the effectiveness of a promotion offer on the particular item at the two or more store locations during the promotion period, the systems does not take into account other factors that may come into action for increase in the sale of the particular item during the promotion period. For instance, when a promotion such as discount is offered on apparel in 50 stores of the business merchant, the conventional evaluations systems while evaluating the effectiveness of the discount being offered on the apparel in the 50 stores may not take into consideration various other factors that may have had an effect on the overall sales of the promoted product, such as few stores among the 50 stores may have undergone huge remodel or maybe several store locations may have faced a shutdown due to bad weather which may have affected the outcome of the sales of the promoted product during the promotion period.

All of the events that may result to boost sales, or increase traffic in stores, or clear merchandise when not taken into consideration while evaluating the effectiveness of the promotion, typically results in misleading data which is potentially ineffective for business strategists. Therefore, the baselines determined without taking into consideration overlapping promotions and/or factors occurring at the store locations during the promotion period are essentially inaccurate when used to analyze special promotional activities, and the businesses that rely on inaccurate baselines may excessively lower prices, ignore specific consumer groups, overlook product characteristics, and eventually misidentify losses as profits.

Furthermore, as the Internet technology era allows for interconnectivity between the different computing systems, many businesses typically store data related to consumers and promotions as separate datasets within one or more databases as the size of the data is very large. As the processing power of the computing systems allow for greater computer functionality, many existing methods to analyze promotional activities offered by businesses use computing technology to calculate effectiveness of a promotion strategy.

However, since the implementation of these more sophisticated and computer-implemented tools for promotion evaluation have been adopted, several shortcomings in these technologies have been identified and have created a new set of challenges in addition to problem of the inaccurate evaluation of the effectiveness of the promotion. For example, existing and conventional methods fail to provide fast and efficient analysis due to a high volume of customer information existing on different networks and computing infrastructures, as many businesses store relevant consumer data in different databases, and the consumer data may not be readily available in a structured format for evaluation. Managing such data is typically difficult due to the high volume of data as well as the diversity of databases in which the data is stored (for example, cross-platform incompatibility). In addition, the existing and conventional methods consume high processing/computer power and are typically ineffective and inefficient as they utilize a “brute force” approach, which calculates every possible permutation and combination of lift values based on consumer information for evaluating the effectiveness of the promotion. Therefore, firstly there is a need for a technical solution for capturing and storing the requisite datasets by the business to accurately measure effectiveness of the business promotions which will be a valuable addition to an analytic capability of business organizations that run large scale promotions.

### SUMMARY

Disclosed herein are systems and methods capable of addressing the above-described shortcomings and may also provide any number of additional or alternative benefits and advantages. For example, the embodiments described herein comprises methods and systems that provide an efficient and faster technique for processing large control datasets, which would allow businesses to profile consumer behavior in a more efficient manner than possible with human-intervention or conventional computer data-driven analysis. The methods and systems described herein further provide a network and computer-specific set of rules to produce efficient and accurate evaluation results when facing a high number of combinations and permutation of control strategies. For example, the methods and systems may provide a sales forecast that accounts for any type of concurrent events to boost sales, or increase traffic in stores, or all of the above in a network by automatically identifying events overlap at one or more locations of business, and decoupling the concurrent events to accurately measure effectiveness of the business promotions. These features allow performing large work such as time-consuming analysis, data-entry tasks, and generating lift datasets, in a more efficient manner by using less computing power than conventional approaches.

In one embodiment, a computer-implemented method, which may be executed by one or more servers, comprises receiving, by a server, a request to execute a first control strategy algorithm associated with entities. The computer-implemented method further comprises upon receiving the request, generating, by the server, a first instruction to a database to receive data associated with the first control strategy algorithm. The computer-implemented method further comprises upon transmitting the first instruction, receiving by the server from the database, data associated with the first control strategy algorithm. The computer-implemented method further comprises determining, by the server, a start date and an end date associated with a first pre-period and a first post-period associated with the first control strategy algorithm. The computer-implemented method further comprises determining, by the server, a first range, wherein the first range comprises a minimum value associated with the first post-period and a maximum value associated with the first post-period. The computer-implemented method further comprises determining, by the server, a first category of items, wherein the first category of items comprises a category of one or more items associated with the first control strategy algorithm. The computer-implemented method further comprises generating, by the server, a second instruction to the database to receive a second control strategy algorithm associated with the entities. The computer-implemented method further comprises upon transmitting the second instruction, receiving by the server from the database, data associated with the second control strategy algorithm. The computer-implemented method further comprises determining, by the server, a start date and an end date associated with a second pre-period and a second post-period associated with the second control strategy algorithm. The computer-implemented method further comprises determining, by the server, a second range, wherein the second range comprises a minimum value associated with the second post-period and a maximum value associated with second post-period. The computer-implemented method further comprises determining, by the server, a second category of items, wherein the second category of items comprises a category of one or more items associated with the second control strategy algorithm. The computer-implemented method further comprises upon determining that the first category of items comprises items from the second category of items during a common period of the first range and the second range, dynamically adjusting, by the server, the first control strategy algorithm to exclude the processing of any entities that have the first category of items that comprises items from the second category of items during the common period of the first range and the second range. The computer-implemented method further comprises executing, by the server, the adjusted first control strategy algorithm.

It is to be understood that both the foregoing general description and the following detailed description are exemplary and explanatory and are intended to provide further explanation of the invention as claimed.

### BRIEF DESCRIPTION OF THE DRAWINGS

The accompanying drawings constitute a part of this specification and illustrate an embodiment of the invention and together with the specification, explain the invention.

FIG. 1 shows components of an exemplary system to analyze sales of one or more items, according to an exemplary embodiment.

FIG. 2 is a block diagram showing components of an exemplary system to analyze sales of one or more items, according to an exemplary embodiment.

FIG. 3 shows a flow diagram illustrating a method to adjust a control strategy to account for overlapping events, according to an exemplary embodiment.

FIG. 4A shows a table of inputs for analyzing a current event on one or more products of a business merchant at one or more sites, according to an exemplary embodiment.

FIG. 4B shows a table of inputs for analyzing a first event on one or more products of a business merchant at one or more sites, according to an exemplary embodiment.

FIG. 4C shows a table of inputs for analyzing a second event on one or more products of a business merchant at one or more sites, according to an exemplary embodiment.

FIG. 4D shows a table of post-period range calculation for events, according to an exemplary embodiment.

FIG. 4E shows a table of pre-period date range and post-period date range calculation for a current event, according to an exemplary embodiment.

FIG. 4F shows current event pre-period overlapping with other events time periods, according to an exemplary embodiment.

FIG. 4G shows current event post-period overlapping with other events time periods, according to an exemplary embodiment.

FIG. 4H shows a table of inputs for evaluating a current category, according to an exemplary embodiment.

FIG. 4I shows current category pre-period overlapping with other events category, according to an exemplary embodiment.

FIG. 4J shows current category post-period overlapping with other events category, according to an exemplary embodiment.

### DETAILED DESCRIPTION

Reference will now be made to the exemplary embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

In an embodiment, methods and systems of the present disclosure automatically identify instances where an entity (e.g., a site location of a business merchant) that is being analyzed for a test event (or promotion) is involved in another test event affecting a similar category of item that is being analyzed during a same timeframe. In other words, the methods and systems described herein automatically identifies overlapping events during a same timeframe at the entity that is being analyzed. The overlapping events correspond to an instance where an item and entity combination has multiple promotions active for the same time period. The overlapping events/promotions identified are accounted for in forecasting a lift over a baseline forecast in response to a promotion to estimate the effects of each promotion independently. The algorithm and/or software models executed by the methods and the systems described herein to automatically identify concurring and/or overlapping events occurring at the same entity calculates each event's date range, marks events as overlapping based on date range and primary category of items affected, and consequently calculate overlapping items in overlapping events. The identification of the concurring events by the methods and systems of the present disclosure ensures that results of the analysis of the test event at a given entity are accurate because they are not impacted by other tests going on the same given entity during the same timeframe. Upon identification of the concurring events occurring at one or more entities, the systems and methods allow adjustment for that concurrent event activity by either filtering (e.g., excluding) those entities from the analysis, or blacking out the dates of the concurrent event activity, or matching the entities (e.g., matching a test entity to a control entity in the event based on if those entities were overlapping).

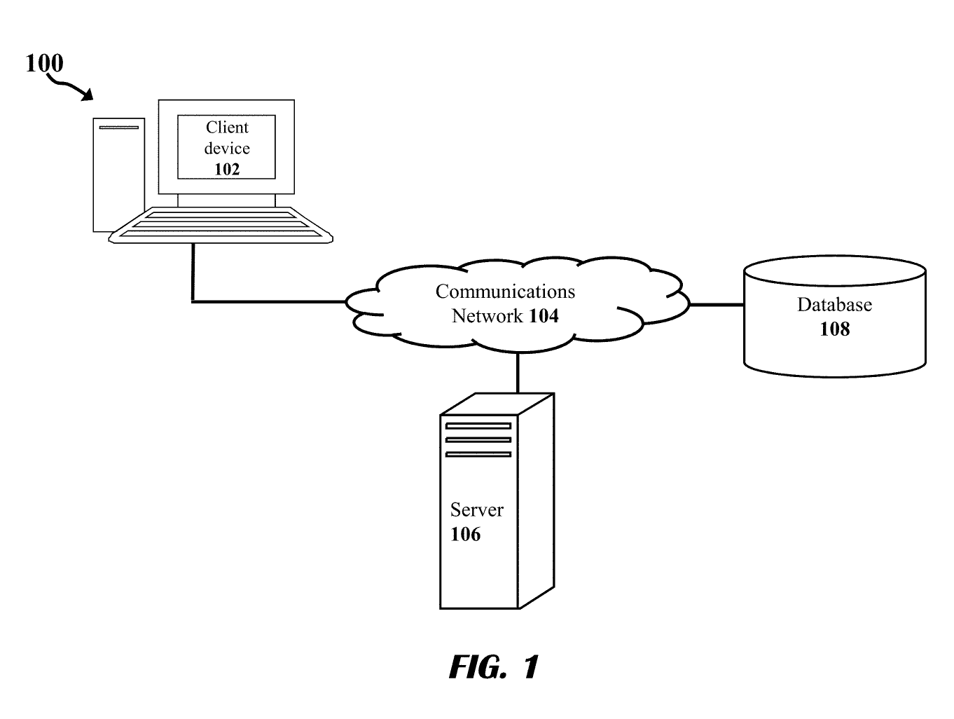

FIG. 1 shows components of an exemplary system 100 to analyze sales of one or more items, according to an exemplary embodiment. The exemplary system 100 comprises a client device 102, a communications network 104, a server 106, and a database 108. The client device 102 is connected to the server 106 and the database 108 via the communications network 104. The client device 102 may include client computers and one or more merchant point-of-sale (POS) systems.

The communications network 104 refers to a medium that also connects various client devices 102 and the database 108 of the system 100. The examples of the communications network 104 include, but are not limited to, private or public LAN, WLAN, MAN, WAN, and the Internet. The communications network 104 can include both wired and wireless communications according to one or more standards and/or via one or more transport mediums. The communication over the communications network 104 may be performed in accordance with various communication protocols such as Transmission Control Protocol and Internet Protocol (TCP/IP), User Datagram Protocol (UDP), and IEEE communication protocols. In one example, the communications network 104 includes wireless communications according to Bluetooth specification sets, or another standard or proprietary wireless communication protocol. The communications network 104 can also include communications over a cellular network, including, e.g. a GSM (Global System for Mobile Communications), CDMA (Code Division Multiple Access), EDGE (Enhanced Data for Global Evolution) network.

The client device 102 may be any portable or non-portable device such as a computing device. The computing device refers to a computer with a processor/microcontroller and/or any other electronic component that performs one or more operations according to one or more programming instructions. The examples of the computing device include, but are not limited to, a desktop computer, a laptop computer, a personal digital assistant (PDA), a tablet computer, and the like. The client device 102 is capable of communicating with the server 106 through the communications network 104 using wired or wireless communication capabilities.

The client device 102 may include one or more input/output devices configured to allow user interaction with one or more programs configured to communicate with the server 106 configured to perform promotional offers evaluation for the businesses. In one example, the client device 102 include computers from which users access and interact with the server 106 configured to perform promotional offers evaluation. In another example, the client device 102 may run a web browser that accesses and presents a web application executed by the server 106 or another device, and allows a user to generate a report including sales data for one or more items/products sold by a business merchant. In yet another example, the client device 102 execute an application outside of a web browser, for example, an operating system specific application like a Windows application or Apple iOS application that accesses and presents information processed to the server 106 configured to perform promotional offers analysis.

The client device 102 may further include Point-of-Sale (POS) systems in the system 100 and may be employed by business merchants as a means for conducting sales transactions. The POS systems may be electronic devices, or collections of electronic devices, configured to generate transaction data when a transaction is executed. The non-limiting examples of the POS systems may include cash registers, barcode scanners, magnetic stripe card readers, EMV chip card readers, tablet computers, laptop computers, and the like.

In an embodiment, any data transmitted over the communications network 104, for example, from the client device 102 and/or the POS systems to the database 108 may be formatted in accordance with a variety of different communications protocols. For example, all or a portion of the network 104 can be a packet-based, Internet Protocol (IP) network that communicates data from the client device 102 to the database 108 in Transmission Control Protocol/Internet Protocol (TCP/IP) packets. In one example, the transaction data generated by the POS systems may be generated, or otherwise formatted, as sales data in accordance with a formatting specification or protocol expected by the server 106. Additionally, the POS systems may generate or otherwise format the sales data as entity transaction records, which may be stored into the business merchant entity records of the database 108.

The database 108 store information associated with volume and time-period of the sales of items/products of business merchant(s). Examples of such information includes past actual sales value for the various items sold by the business merchant at a number of locations, for example, a number of stores in a number of different geographical locations. In one instance, the POS systems receives and processes sales data associated with customer sales transactions of the business merchant at various locations of the business merchant. The server 106 can periodically retrieve raw POS sales data from the POS systems and can store the data or process and then store the data in the database 108. In another example, the server 106 can retrieve raw POS sales data for a pre-period and a post-period for a given item from one or more stores in a number of different geographical locations from the POS systems, and can store the data or process and then store the data in the database 108 for a pre-period and a post-period of the promotional time-period. In another example, the POS systems are configured to periodically push the sales data over the communication network 104 to the server 106 and/or the database 108.

The database 108 may be hosted on one or more computing devices comprising non-transitory machine-readable storage media capable of receiving, storing, updating, and/or querying business merchant sales records of the database 108 containing the sales data. The database 108 may be a logical construct of data files that are stored in non-transitory machine-readable storage media, such as a hard disk or computer memory, controlled by software modules of a database program (for example, SQL), and a related database management system (DBMS) that executes the code modules (for example, SQL scripts) for various data queries and other management functions. The database 108 may be hosted on any computing devices comprising storage media capable of storing the sales data received from the POS systems, and a processor, or in communication with a processor, capable of executing the various commands of the DBMS. The non-limiting examples of the computing hardware that may host the database 108 may include a server computer, a desktop computer, a laptop, or the like.

In operation, the database 108 may submit merchant sales records to the server 106 in order to determine the effectiveness of a promotion(s) offered by a merchant business. The business merchant sales records may be exclusive information belonging to the business merchant, and is securely transmitted to the server 106 using a secure data transfer and storage apparatus.

The server 106 may include one or more modules to do promotion evaluation and the future sales forecast for the business merchants. The server 106 may perform various analytics on sales data records stored in the database 108, and may be further employed to calculate lift for a product of the business merchant that is attributable to a sales promotion by taking into account the concurring events. The server 106 can be any of several different types of network devices. The non-limiting examples of the server 106 include a desktop computer, a laptop computer, a personal digital assistant (PDA), a tablet computer, a data processing appliance, web server, specialized media server, or another type of network device. The server 106 may be implemented in hardware, software, or a combination of both and can include one or more functional modules configured to execute various functions attributed to the server 106. Additionally, although example system FIG. 1 includes one server 106, other examples include a number of collocated or distributed servers configured to process sales and other types of data associated with the products and other items sold by the business merchant and stored in the database 108 individually or in cooperation with one another.

Although the database 108 and the server 106 are illustrated as separate components in the system 100 of FIG. 1, in other examples the components are combined or each is distributed amongst more than one device. In one example, the server 106 stores the database 108 and control the database 108 to periodically retrieve sales data from the POS system over the communications network 104. In another example, the database 108 and/or POS system are distributed among a number of separate devices, e.g., a number of database servers, and the server 106 includes a number of co-located or distributed servers configured to operate and/or in cooperation with one another and with the various devices comprising the database 108 and/or POS system.

Regardless of the particular configuration of system 100 or other example systems, the system 100 may be employed that provide a future sales forecast that accounts for any type of concurring/overlapping events to boost sales, or increase traffic in stores, or all of the above. In one example, the server 106 retrieves from the POS system or the POS system pushes actual sales transaction data to the server 106 over the network 104. The sales transaction data is received by the server 106 periodically and stored in the database 108 for different periods of time, for example, in blocks of one or more days, weeks, months, or years. The server 106 retrieves the sales transaction data for one or more products sold by the business merchant and analyzes the sales data to calculate the sales lift for a product or products that is attributable to one or more sales promotions associated with the product(s) at the one or more entities (sites/locations).

In operation, the client device 102 may send a request to the server 106 to analyze various forms of sales data records of one or more items/products. For example, the server 106 is configured to evaluate sales data for a number of items that belong to a same or a different product category for one or more time periods, for example, one or more weeks, one or more months, or one or more years. The items sold by the merchant may be organized into categories of items by the server 106. The category may refer to a set of related items that are grouped together for consolidation of results. Depending on how the items are grouped together, the server 106 may categorize the items under a broader category or a narrower category. In one example, the item category can be a group of a number of items that share one or more attributes or are otherwise related to one another. For instance, the server 106 may group shirts, blazers, and suits into an item category of formal wear. In another example, the server 106 may group t-shirts, jackets, and skirts into an item category of apparel. The item categories generated by the server 106 may not essentially include different types of items that share a similar utility. For instance, item categories include different versions of the same type of item. In one such example, the server 106 organizes different brands of shirts into a shirts category.

The server 106 may retrieve or send a request to retrieve sales data stored on the database 108 for a plurality of items in an item category over a period of time. The database 108 may store data records generated and stored by the client device 102, and may be hosted on any number of computing devices comprising a non-transitory machine-readable storage medium capable of storing data records received from the client device 102 or other computing devices such as POS systems. The database 108 may include a processor capable of executing various tasks according to instructions or requests received from the server 106 such as requests to obtain sales records for one or more items at one or more locations over a period of time.

For example, the server 106 may receive a request to execute a first control strategy algorithm, and upon receiving the request, the server 106 may send a request to the database 108 to receive data associated with a first control strategy algorithm associated with entities involved in an event. The entity may be a site (e.g., a store) or one or more sites (e.g., stores) of a business merchant. In one embodiment, an entity may be a single site (e.g., store) of a business merchant. In another embodiment, the entities may be a plurality of sites (e.g., stores) of a business merchant where each site (e.g., store) may be located in a single city, state, or country or in different cities, states, or countries. The data associated with the first control strategy algorithm may include a first pre-period, a first post-period, and a sale item associated with the first control strategy algorithm.

Upon receiving the data associated with the first control strategy algorithm, the server 106 determines a start date and an end date associated with the first pre-period, and a start date and an end date associated with the first post-period. The first pre-period and the first post-period are time periods associated with the implementation of the first control strategy algorithm (for example, a discount coupon offer) by the server 106. For example, the server 106 may obtain sales data stored on the database 108 for a given sale item (for example, a shirt) associated with an entity (for example, a store located in Boston) for a one-month period before a first promotional offer is provided on the given shirt (first pre-period), and for a one-month period when the first promotional offer is provided on the given shirt (first post-period). In another instance, the server 106 may obtain sales data stored on the database 108 for a plurality of sale items (for example, a plurality of brands of shirts) associated with one or more entities (for example, a store located in Boston and/or New York) for a one-month time period before promotion (first pre-period), and one month period of sales during the promotion period (post-period). In an alternative embodiment, the server 106 can execute this method without using the pre-period data and still use the post-period data for the event(s).

Upon obtaining the pre-period dates and the post-period dates associated with the first control strategy algorithm, the server 106 determines a first range associated with the first control strategy algorithm. In an embodiment, the server 106 determines the first range that corresponds to a minimum value associated with the first post-period and a maximum value associated with the first post-period. Upon determining the first range, the server 106 determines a first category of items from a list of items. The first category of items corresponds to a category of one or more items from the list of items affected by the first control strategy algorithm.

The server 106 generates an instruction to the database 108 to receive data associated with a second control strategy algorithm associated with the entity. The data associated with the second control strategy algorithm may include a second pre-period, a second post-period, and a sale item associated with the second control strategy algorithm.

Upon receiving the data associated with the second control strategy algorithm, the server 106 determines a start date and an end date associated with the second pre-period, and a start date and an end date associated with the second post-period. The second pre-period and the second post-period are time periods associated with the implementation of the second control strategy algorithm (for example, an e-mail coupon offer) by the server 106. For example, the server 106 may obtain sales data stored on the database 108 for a given sale item (for example, a shirt) associated with an entity (for example, a store located in Boston) for a one month period before a second promotional offer is provided on the given shirt (second pre-period), and for a one month period when the second promotional offer is being provided on the given shirt (second post-period). In one embodiment, the server 106 may determine if the post-period of the second control strategy algorithm overlaps with the pre-period or the post period of the first control strategy algorithm. In another embodiment, the server 106 may determine if the second control strategy overlaps with the first control strategy at any time.

Upon obtaining the pre-period dates and the post-period dates associated with the second control strategy algorithm, the server 106 determines a second range associated with the second control strategy algorithm. In an embodiment, the server 106 determines the second range that corresponds to a minimum value associated with the second post-period and a maximum value associated with the second post-period. Upon determining the second range, the server 106 then determines a second category of items from a list of items. The second category of items corresponds to a category of one or more items from the list of items affected by the second control strategy algorithm.

In an embodiment, the server 106 determines whether the first category of items comprises items from the second category of items during a common period of the first range and the second range. For instance, initially the server 106 may compare the first range and the second range to determine whether there is an overlap between the first range and the second range to determine a common period of the first range and the second range. Upon determining there is a common period (or there is overlap between the first range and the second range), the server 106 may then determine whether the first category of items and the second category of items overlap with each other. In other words, the server 106 determines common items between the first category of items and the second category of items during the common period of the first range and the second range.

In some embodiments, the server 106 may dynamically adjust the first control strategy algorithm, upon determining that the first category of items may include items from the second category of items during a common period of the first range and the second range. The server 106 may dynamically adjust the first control strategy algorithm to exclude the processing of the entities that have the first category of items that comprises items from the second category of items during the common period of the first range and the second range. The server 106 may then execute the adjusted first control strategy algorithm. In one instance, the server 106 may adjust the first control strategy algorithm by filtering common entities determined during the common period, and then execute the adjusted first control strategy algorithm. In another instance, the server 106 may further adjust the first control strategy algorithm by blacking out dates of common period, and then execute the adjusted first control strategy algorithm. In yet another instance, the server 106 may further adjust the first control strategy algorithm by filtering common items determined during the common period as well as blacking out dates of the common period, and then execute the adjusted first control strategy algorithm.

In some embodiments, the server 106 upon determining that at least one of the first and the second ranges, and the first and the second categories of items overlap, may generate an instruction to display a notification indicating that the first and second control strategy algorithms are overlapping. The notification may be available for display at user's computing device and/or client's computing device. The user and/or the client on identification of the overlap of at least one of the first and the second ranges and the first and the second categories of items occurring at the entity, may send instructions to the server 106 to adjust the overlapping, by either filtering those overlapping entities from the analysis, or blacking out the dates of the overlapping event activity, or matching test to control on the overlapping activity. In some embodiments, the server 106, upon identification of the overlap of the at least one of the first and the second ranges and the first and the second categories of items occurring at the entity, may send a request to an administrator of the system 100 to adjust for the overlapping activity. The administrator may adjust the overlapping by either filtering those overlapping entities from the analysis, or blacking out the dates of the overlapping event activity, or matching test to control on the overlapping activity from the analysis of promotional activities. The event may correspond to at least one of, but not limited to, a price reduction, rewards for multiple purchases, loyalty card promotions, commercial advertisement, an e-mail offer, coupon promotions, rebate programs, or a natural disaster.

In some embodiments, the server 106 upon identification of the overlap of the at least one of the first and the second ranges and the first and the second categories of items occurring at the entity, may automatically adjust the overlapping by either filtering those overlapping entities from the analysis, or blacking out the dates of the overlapping event activity, or matching test to control on the overlapping activity from the analysis, based on pre-defined instructions provided by the user. The user may provide pre-defined instructions to the server 106 which may be stored in the database 108. The pre-defined instructions may include one or more rules for the server 106 to determine to either to filter the overlapping entities from the analysis, or blacking out the dates of the overlapping event activity based on the number of overlapping events and/or the category of the items being overlapped.

The server 106 may then generate a promotional forecast of future sales (e.g., measuring actual sales performance of a test site versus control site that occurred during a promotional period (and adjusting for overlapping events)) of the one or more items that takes into account concurring events such as promotions, for instance, by filtering the overlapping entities from the overall analysis. In the example embodiment discussed above, only two promotion events are considered, one each for the first control strategy algorithm and the second control strategy algorithm. However, in other embodiments, a larger number of events may be considered, which typically results in a large number of overlapping events being generated.

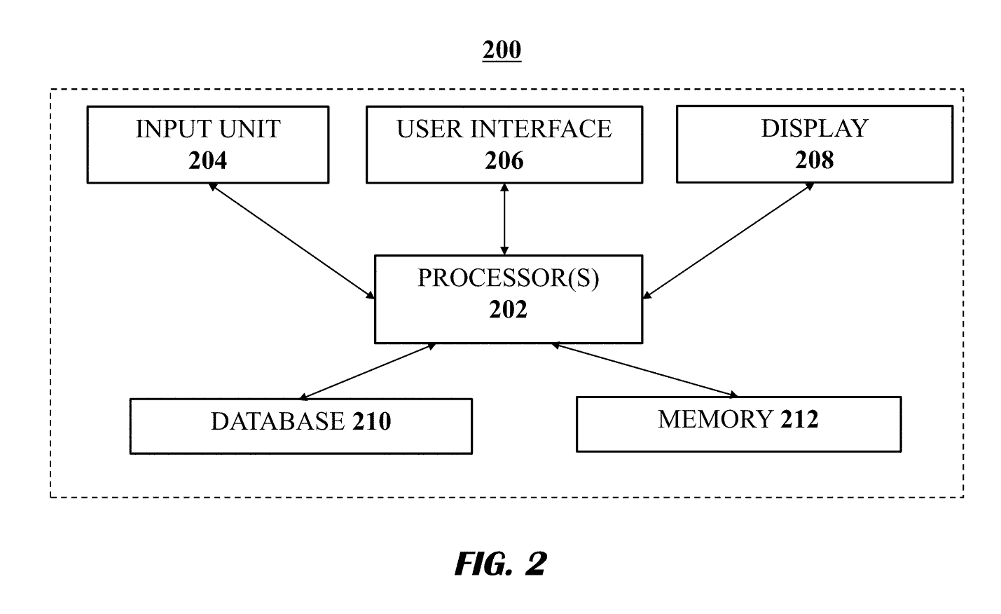

FIG. 2 is a block diagram showing components of an exemplary system 200 to analyze sales of one or more items, according to an exemplary embodiment. The exemplary system 200 comprises one or more processors 202, an input unit 204, a user interface 206, a display 208, database 210, and a memory 212. In one implementation, all the components of system 200 may be connected via an interconnect bus. In another implementation, the one or more processors 202 may be connected to a memory device via a local microprocessor bus, and the remaining components of the system 200 may be connected via one or more input/output buses.

One or more processors 202 control the operations of the system 200. In one embodiment, a single processor may be employed. In another embodiment, a plurality of processors 202 may be employed for configuring the system 200 as a multi-processor system. The processor 202 includes suitable logic, circuitry, and interfaces that are operable to execute one or more instructions to perform predetermined operations such as calculating a baseline and a sales life for the businesses. The processor 202 can be realized through a number of processor technologies known in the art. The examples of the processor include, but are not limited to, an x86 processor, an ARM processor, a Reduced Instruction Set Computing (RISC) processor, an Application-Specific Integrated Circuit (ASIC) processor, or a Complex Instruction Set Computing (CISC) processor. The processor 202 may also include a Graphics Processing Unit (GPU) that executes the set of instructions to perform one or more processing operations.

The input unit 204 may be a keyboard, mouse, pointer, or other input generating device to facilitate input of control instructions by the circuit designer to the processor 202. In one embodiment, the input unit 204 provides a portion of the user interface 206 for the system 200, and may include an alphanumeric keypad for inputting alphanumeric and other key information along with a cursor control device such as a mouse, a trackpad or stylus. A display 208 of the system 200 may include a cathode ray tube (CRT) display, liquid crystal display (LCD), plasma, or light emitting diode (LED) display. In some examples, the display 208 provides some or all of the functionality of a user interface 204 of computing device. For instance, the display 208 can be a touch-sensitive and/or presence-sensitive display that can display a graphical user interface (GUI) and detect input from a user in the form of user input gestures. A graphics subsystem may receive textual and graphical information and process the information for output to the display 208.

The user interface 206 allows a user of computing device to interact with computing device. Examples of user interface 206 include, but are not limited to, a keypad embedded on computing device, a keyboard, a mouse, a roller ball, buttons, or other devices that allow a user to interact with computing device. In some examples, computing device does not include user interface 206, and the user interacts with computing device with the display 208 (e.g., by providing various user gestures). In some examples, the user interacts with computing device with the user interface 206 and the display 208.

The database 210 can be configured to store information within computing device during operation. The database 210 in some examples, is described as a computer-readable storage medium. In some examples, database 210 include a temporary memory, meaning that a primary purpose of database 210 is not long-term storage. The database 210 in some examples, described as a volatile memory, meaning that database 210 do not maintain stored contents when the computer is turned off. Examples of volatile memories include random access memories (RAM), dynamic random access memories (DRAM), static random access memories (SRAM), and other forms of volatile memories known in the art. In some examples, database 210 is used to store program instructions for execution by one or more processors 202. The database 210, for example, are used by software or applications running on client device to temporarily store information during program execution.

The database 210, in some examples, also include one or more computer-readable storage media. The database 210 can be configured to store larger amounts of information than volatile memory. The database 210 can further be configured for long-term storage of information. In some examples, the database 210 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

A memory 212 may also be provided in the system 200. The memory 212 may be a non-volatile storage device for storing data and instructions, to be used by the processor 202. The memory 212 may be implemented with a magnetic disk drive, an optical disk drive, a solid state device, or an attachment to a network storage. The memory 212 may comprise one or more memory devices to facilitate storage and manipulation of program code, set of instructions, tasks, data, PDKs, and the like. Non-limiting examples of memory implementations may include, but are not limited to, a random access memory (RAM), a read only memory (ROM), a hard disk drive (HDD), a secure digital (SD) card, a magneto-resistive read/write memory, an optical read/write memory, a cache memory, or a magnetic read/write memory. The memory may include one or more instructions that are executable by the processor 202 to perform specific operations.

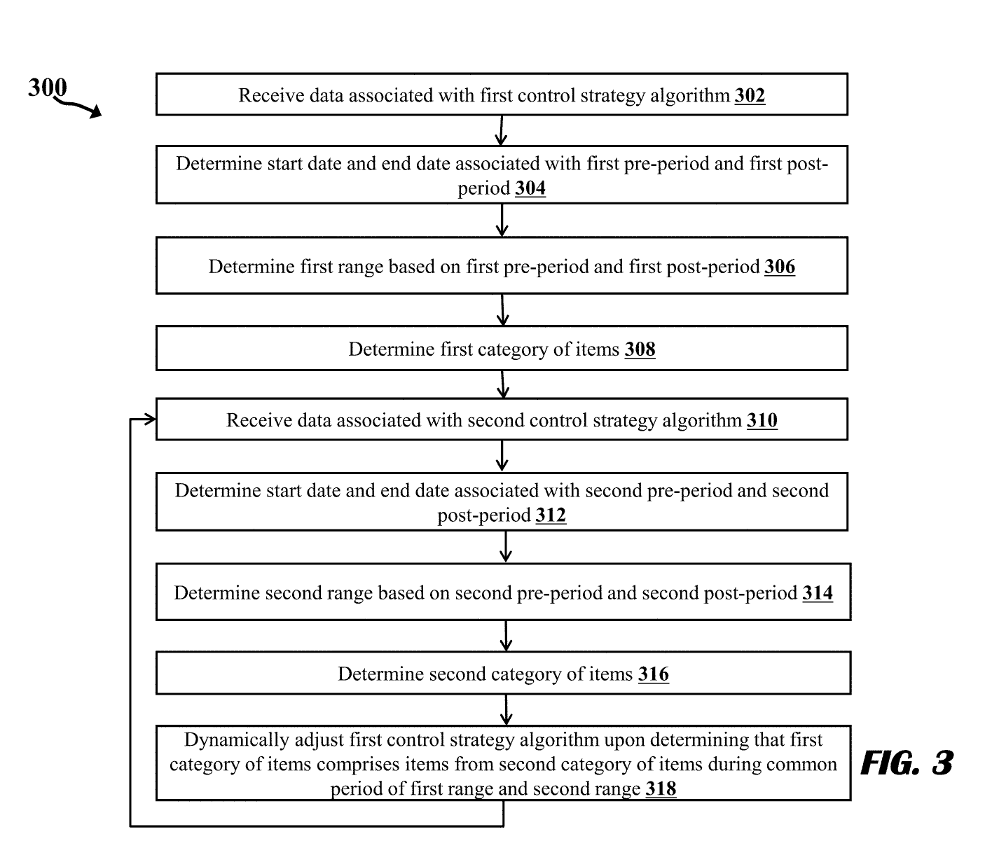

FIG. 3 shows a flow diagram illustrating a method 300 to adjust a control strategy to account for overlapping events, according to an exemplary embodiment. In some embodiments, the steps of the flow diagram of FIG. 3 is implemented by software stored in memory or other computer readable or tangible medium, and executed by one or more processors of a server. In some embodiments, the steps of the flow diagram of FIG. 3 may be performed by hardware (for example, ASIC or FPGA), or any combination of hardware and software.

At step 302, a server receives a request to execute a first control strategy algorithm associated with an entity, and upon receiving the request, the server sends an instruction to a database to receive data associated with the first control strategy algorithm. The entity may be any given site location of one or more locations of a business merchant. In one embodiment, the entity may be a single site (or a store site of a business merchant). In another embodiment, the entities may be a plurality of sites (or a plurality of store sites of a business merchant) in a single city, state, or country or in different cities, states, or countries. The data associated with the first control strategy algorithm may include a first pre-period, a first post-period, and a sale item associated with the first control strategy algorithm.

At step 304, a server determines a start date and an end date associated with a first pre-period and a first post-period associated with the first control strategy algorithm. Upon receiving the data associated with the first control strategy algorithm associated with the entity, the server determines the start date and the end date associated with the first pre-period, and the start date and the end date associated with the first post-period.

In some embodiments, the first pre-period and the first post-period are time periods associated with the implementation of the first control strategy algorithm (for example, a discount coupon offer) by the server. The first pre-period corresponds to a period of time leading up to a promotion/event. The first post-period corresponds to a period of time of the promotion/event. For example, the server may obtain sales data stored on the database for a given sale item (for example, a shirt) at an entity (for example, a store located in Boston) for one month period before a first promotional offer is provided on the given shirt (first pre-period), and for one month period when the first promotional offer is being provided on the given shirt (first post-period). In alternate embodiments, the duration of the first and second pre-period may by any number of days, for example 1 day, 1 week, 1 month, or 1 year without moving out from the scope of the disclosed embodiments. In another instance, the server may obtain sales data stored on the database for a plurality of sale items (for example, a plurality of brands of shirts) at one or more entities (for example, a store located in Boston and/or New York) for a one-month time period before promotion period (first pre-period), and one-month period of sales during the promotion period (first post-period).

At step 306, a server determines a first range based on the first pre-period and the first post-period. Upon obtaining the pre-period and the post-period dates associated with the first control strategy algorithm, the server determines a first range associated with the first control strategy algorithm. In an embodiment, the server determines the first range that corresponds to a minimum value associated with the first post-period and a maximum value associated with the first post-period.

At step 308, a server determines a first category of items. Upon determining the first range, the server determines a first category of items. The first category of items corresponds to a category of the one or more items from the set of items affected by the first control strategy algorithm.

At step 310, a server receives data associated with a second control strategy algorithm. The server generates an instruction to the database to receive data associated with the second control strategy algorithm associated with an entity. The data associated with the second control strategy algorithm may include a second pre-period, a second post-period, and a sale item associated with the second control strategy algorithm.

At step 312, a server determines a start date and an end date associated with a second pre-period and a second post-period associated with the second control strategy algorithm. Upon receiving the data associated with the second control strategy algorithm associated with the entity, the server determines the start date and the end date associated with the second pre-period, and the start date and the end date associated with the second post-period. The second pre-period and the second post-period are time periods associated with the implementation of the second control strategy algorithm (for example, an e-mail coupon offer). For example, the server may obtain sales data stored on the database for a given sale item (for example, a shirt) at an entity (for example, a store located in Boston) for a one-month period before a second promotional offer is provided on the given shirt (second pre-period), and for a one-month period when the second promotional offer is provided on the given shirt (second post-period).

At step 314, a server determines a second range based on the second pre-period and the second post-period. Upon obtaining the pre-period and the post-period dates associated with the second control strategy algorithm, the server determines a second range associated with the second control strategy algorithm. In an embodiment, the second range corresponds to a minimum value associated with the second post-period and a maximum value associated with the second post-period.

At step 316, a server determines a second category of items. Upon determining the second range, the server then determines a second category of items. The second category of items corresponds to a category of one or more items from a list of items affected by the second control strategy algorithm.

At step 318, a server may dynamically adjust the first control strategy algorithm upon determining that first category of items may include items from second category of items during common period of first range and second range. In other words, the server upon determining a commonality between the first and second ranges, and the categories associated with the first control strategy algorithm and the second control strategy algorithm, may dynamically adjust the first control strategy algorithm and execute the adjusted first control strategy algorithm. The server may dynamically adjust the first control strategy algorithm to exclude the processing of the entities that have the first category of items that comprises items from the second category of items during the common period of the first range and the second range. For instance, the server may adjust the first control strategy algorithm by filtering common entities determined during the common period and then execute the adjusted first control strategy algorithm. In another instance, the server may further adjust the first control strategy algorithm by blacking out dates of common period and then execute the adjusted first control strategy algorithm. In yet another instance, the server may further adjust the first control strategy algorithm by filtering common entities determined during the common period as well as blacking out dates of the common period, and then execute the adjusted first control strategy algorithm.

In operation, the server may initially compare the first range and the second range to determine whether there is a common range between the first range and the second range. Upon determining there is common range and/or overlap between the first range and the second range, the server may determine whether there are common items between first category of items and the second category of items during the common range period. When the server determines that there are common items during a common range period, the server may generate an instruction to display a notification indicating the overlapping between with the first and the second control strategy algorithms. The notification may be sent for display by the server, and may be available for display at client's computing device or a systems administrator's computing device.

In some embodiments, the client and/or the administrator of the system on receiving the notification of identification of the overlap of at least one of the first and the second ranges and the first and the second categories of items occurring at the entity, may execute one or more software modules of the system to adjust the overlapping by one or more action such as filtering the entities from the analysis where there is an overlap of events, or blacking out the dates of the overlapping event activity from the overall inputs being used for analysis of promotions, or matching the entities. The event may correspond to at least one of a price reduction, rewards for multiple purchases, loyalty card promotions, commercial advertisement, an e-mail offer, coupon promotions, rebate programs, or a natural disaster.

In some embodiments, the server upon identification of the overlap of the at least one of the first and the second ranges, and the first and the second categories of items occurring at the entity, may send a request to a user to adjust for the overlapping activity while analyzing the promotions at the entity. The user may adjust the overlapping by either filtering the entities from the analysis where there is an overlap, or blacking out the dates of the overlapping event activity, or matching the entities. In another embodiment, the server upon identification of the overlap of the at least one of the first and the second ranges and the first and the second categories of items occurring at the entity, may automatically adjust the overlapping by either filtering those entities from the analysis where there is an overlap, or blacking out the dates of the overlapping event activity, or matching the entities, based on pre-defined instruction provided by the user. In yet another embodiment, the server upon identification of the overlap of the at least one of the first and the second ranges and the first and the second categories of items occurring at the entity, modifies a sequel code (SQL) of the one or more software's being executed by the server to perform the analysis of the data associated with the control strategy algorithms.

In some embodiments, the server may generate a baseline and sales lift for the one or more items using one or more baseline creation methods by taking into consideration the overlap between the first and the second ranges, and the first and the second categories of items. For instance, the server while calculating the sales lift, may decouple the overlapping events by either filtering the entities where there is an overlap out of analysis, or blacking out the dates of the overlapping event activity, or matching test to control on the overlapping activity, and thereby generates a forecast of future sales of the one or more items that takes into account overlapping and/or concurring events.

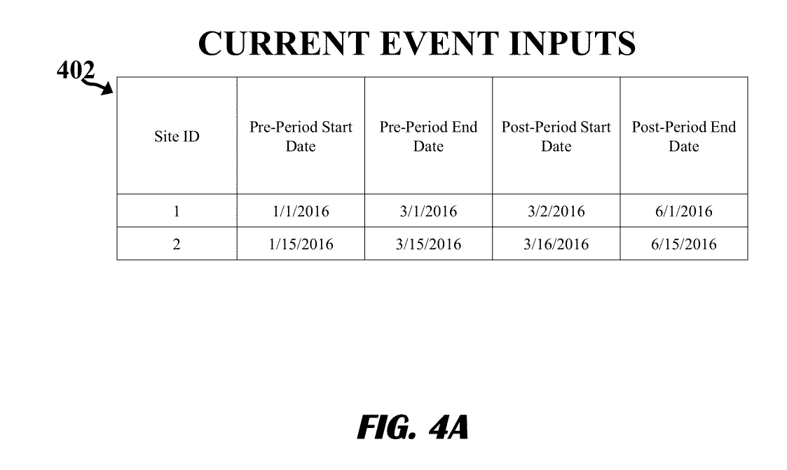

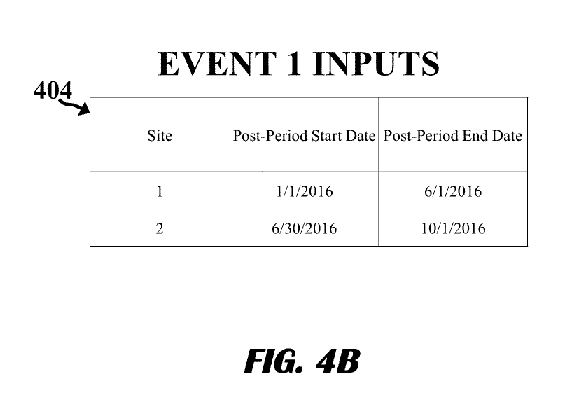

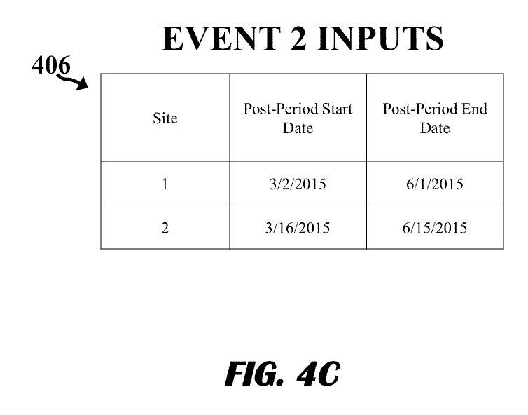

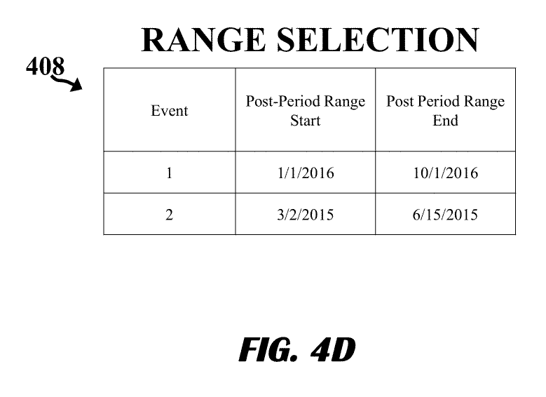

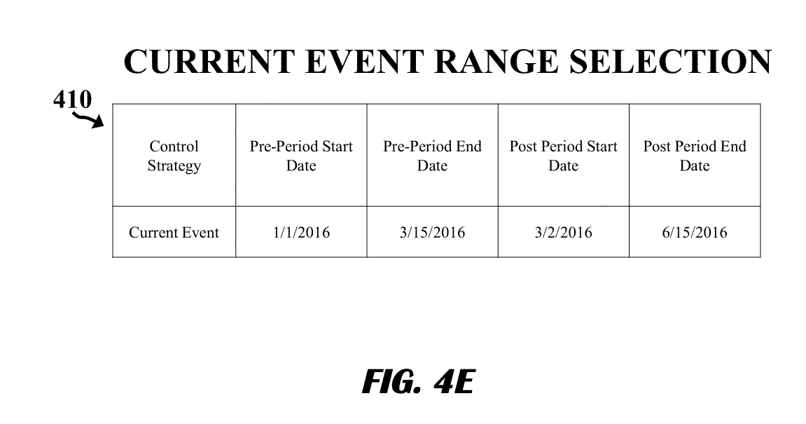

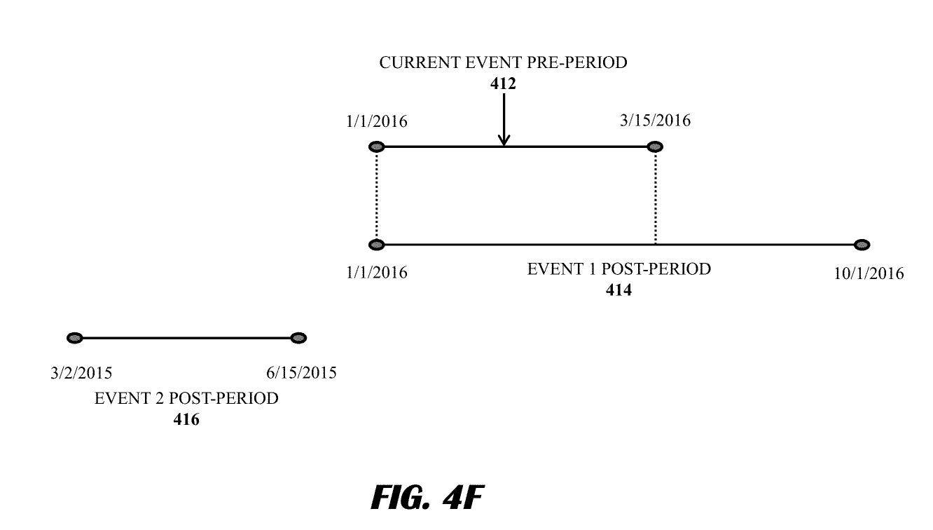

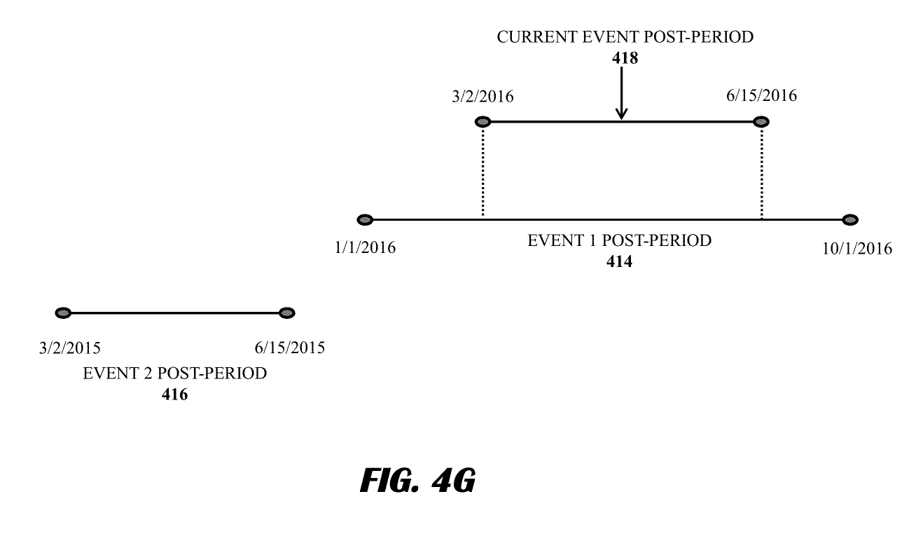

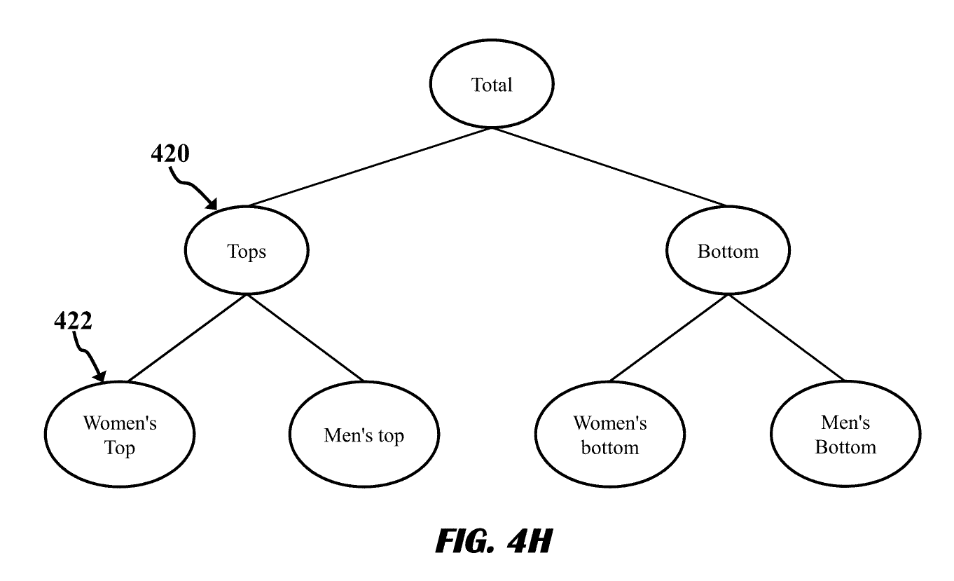

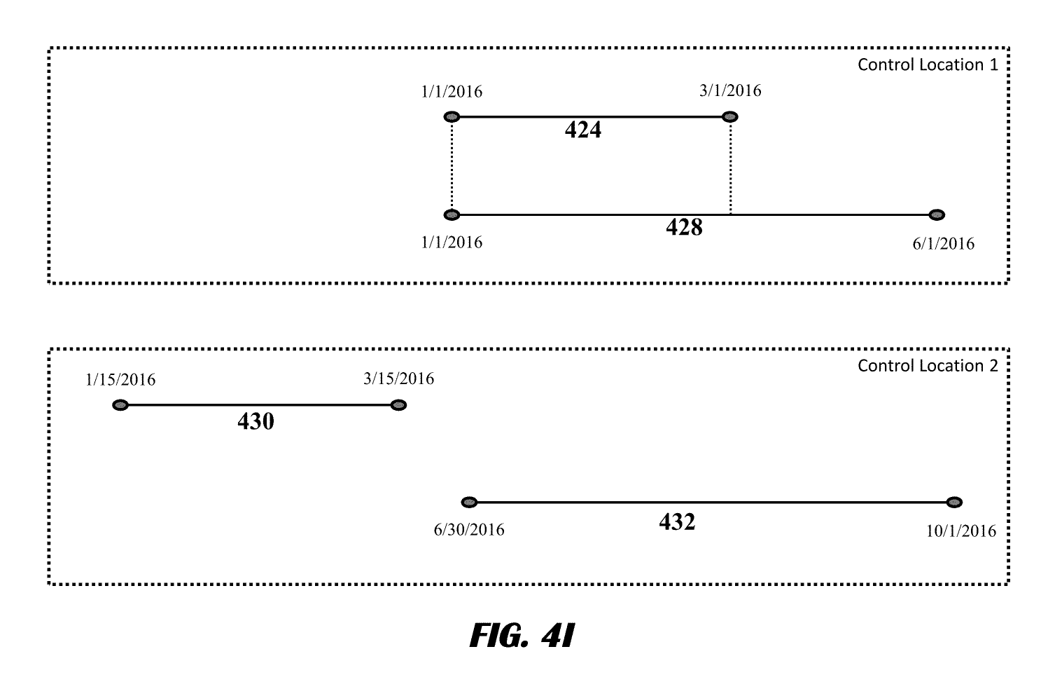

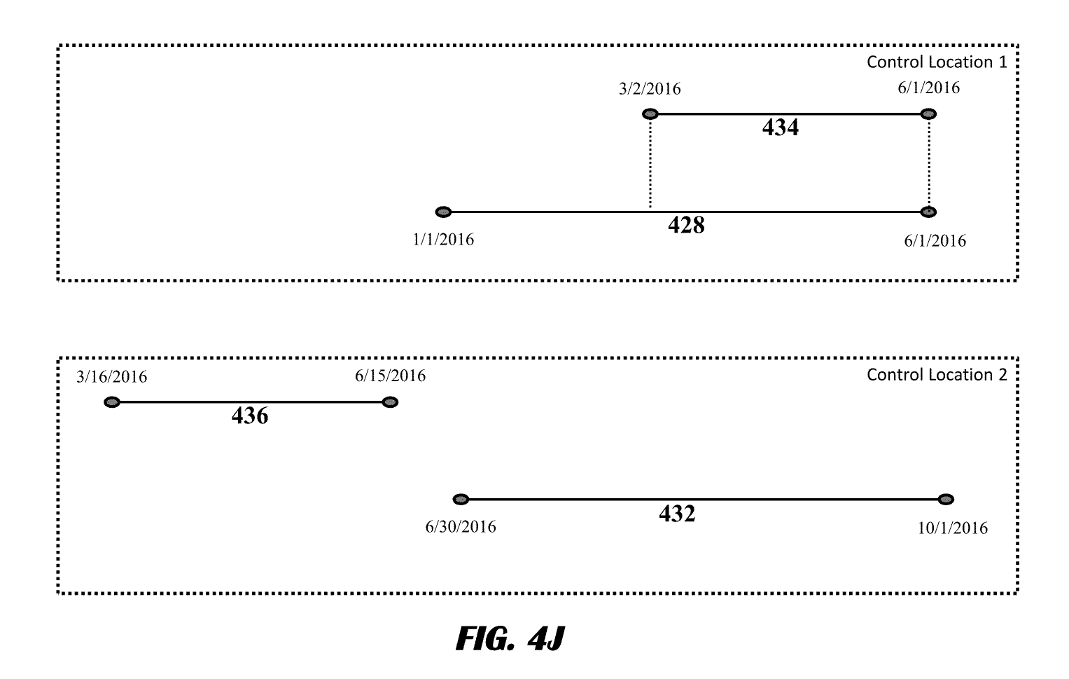

FIG. 4A-FIG. 4J shows an example illustrating the execution of the systems and methods of the present disclosure to analyze sales of one or more items, according to an exemplary embodiment. FIG. 4A shows a table 402 of inputs for analyzing a current event on one or more products of a business merchant at one or more sites, according to an exemplary embodiment. In the illustrated example of the FIG. 4A, the current event may be a discount coupon being offered by a business merchant on the one or more products at the one or more sites. In an embodiment, a server retrieves a list of test entities and control entities pre-period and post-period start dates and end dates associated with the current event from database. The data associated with the test entities may correspond to data associated with a subset of customers (test group) who are identified as targets of the current event (for instance, discount coupon). The data associated with the control entities may correspond to data associated with a sample of comparable customers who are not part of the current event (control group).

In the example shown, the server obtains a pre-period start date, a pre-period end date, a post-period start date, and a post-period end date for the entities (Site 1 and Site 2) of the business merchant. The pre-period start date and the pre-period end date correspond to the dates before the control event was initiated. In other words, the pre-period start date and the pre-period end date correspond to the dates leading to the control event. The post-period start date and the post-period end date correspond to the dates when the control event was initiated. In other words, the post-period start date and the post-period end date correspond to the dates of the current event promotion period.

FIG. 4B shows a table 404 of inputs for analyzing a first event (event 1) on one or more products of a business merchant at one or more sites, according to an exemplary embodiment. In the illustrated example of the FIG. 4B, the first event may be a remodel of site(s) of a business merchant. In an embodiment, a server obtains a list of control entities post-period start dates and post-period end dates associated with the first event for the Site 1 and Site 2 of the business merchant from the database. The post-period start date and the post-period end date correspond to the dates when the first event was initiated. In other words, the post-period start date and the post-period end date correspond to the dates of the first event period.

FIG. 4C shows a table 406 of inputs for analyzing a second event on one or more products of a business merchant at one or more sites, according to an exemplary embodiment. In the illustrated example of the FIG. 4C, the second event may be an e-mail offer being offered by a business merchant on the one or more products at the one or more sites. In an embodiment, a server obtains a list of control entities post-period start dates and post-period end dates associated with the second event for the Site 1 and Site 2 of the business merchant from the database. The post-period start date and the post-period end date correspond to the dates when the second event was initiated. In other words, the post-period start date and the post-period end date correspond to the dates of the second event period.

FIG. 4D shows a table 408 of a post-period range calculation for events, according to an exemplary embodiment. The server calculates the overall post-period date range for the event 1 (first event) and event 2 (second event) using the data retrieved from the database as illustrated in the FIG. 4B and FIG. 4C. In an embodiment, the server calculates the overall post-period date range for the first event and second event by taking a minimum of the post-period start date and maximum of the post-period end date in all entities (e.g., site locations) within each event (first event and second event) (e.g., calculate a range for the first event by finding minimum and maximum dates across the site locations in the first event, then do the same calculation for the second event). For instance, the server calculates the overall post-period date range for the first event by taking a minimum of the post-period start date and maximum of the post-period end date for the first event shown in FIG. 4B. The minimum post-period start date across both the sites is January 1, and the maximum post-period end date across both of the sites is October 10. The server further calculates the overall post-period date range for the second event by taking a minimum of the post-period start date and maximum of the post-period end date for the second event shown in FIG. 4C. The minimum post-period start date across both the sites of the second event is March 2 and the maximum post-period end date across both the sites of the event 2 is June 15.

FIG. 4E shows a table 410 of a pre-period date range and a post-period date range calculation for a current event, according to an exemplary embodiment. The server calculates the pre-period date range and the post-period date range for the current event. In order to calculate the pre-period date range for the current event, the server selects a minimum of the pre-period start date to a maximum of the pre-period end date associated with both sites of the current event as shown in the FIG. 4A. The minimum pre-period start date for both the sites is January 1, and the maximum pre-period end date for both the sites is March 15 as shown in the FIG. 4A. The server calculates the post-period date range for the current event by taking a minimum of post-period start date to a maximum of the post-period end date associated with both sites of the current event as shown in the FIG. 4A. The minimum post-period start date for both the sites is March 2, and the maximum post-period end date for both the sites is June 15 as shown in the FIG. 4A.

FIGS. 4F & 4G, shows current event pre-period and current event post-period overlapping with other events time-periods, according to an exemplary embodiment. In order to determine if the events overlap in time, the server determines if the current event pre-period 412 or the current event post-period 418 overlaps with the post-period of the first event 414 and the post-period of the second event 416.

FIG. 4F shows current event pre-period 412 overlapping with other events time periods, according to an exemplary embodiment. In some embodiments, the server initially determines the overlapping of events by comparing the current event pre-period 412 with the first event post-period 414 and the second event post-period 416. The server determines that the current event pre-period 412 is overlapping with the time-periods of the first event and the second event, when the current event pre-period end date is greater than or equal to the first event and the second event post-period start date, and when the first event and the second event post-period end date is greater than or equal to the current event pre-period start date. As shown in the example illustrated of the FIG. 4F, the first event overlaps with the current event, whereas the second event does not overlap with the current event.

FIG. 4G shows a current event post-period 418 overlapping with other events time periods, according to an exemplary embodiment. In order to determine if the events overlap in time-periods, the server determines if the post-period of the first event 414 and the post-period of the second event 416 overlap with the current event post-period 418.

In some embodiments, the server determines the overlapping of events by comparing the current event post-period 418 with the first event post-period 414 and the second event post-period 416. The server determines that the current event post-period 418 is overlapping with the time periods of the first event and the second event, when the current event post-period end date is greater than or equal to the first event and the second event post-period start date, and when the first event and the second event post-period end date is greater than or equal to current event post-period start date. As shown in the example illustrated in the FIG. 4F and FIG. 4G, the first event overlaps with the current event, whereas the second event does not overlap with the current event.

The primary category of the first event affected due to the overlapping of the first event and the current event for example is, women tops. In order to determine whether the primary category affected of the first event overlaps with the primary category of the current event, the server may determine whether the primary category affected of the first event is equal to the current event primary category affected. In some embodiments, in order to determine whether the primary category affected of the first event overlaps with the primary category of the current event, the server may determine whether the primary category affected of the first event is a descendant or a parent to the current event primary category affected. For instance, as depicted in FIG. 4H, the server determines that the primary category affected of the first event (women's top 422) is a descendant to the current event primary category affected (tops 420), and as a result the primary category affected of the first event (women's top 422) overlaps with the current event primary category affected (tops 420). Therefore, the first event overlaps with the current event, both in terms of the time-period and the primary category affected. The server then marks the first event as overlapping event, and sends a notification to an administrator of the system regarding the identification of the overlapping event. The server further determines if there is any overlapping between the entities of the current event and the entities of the first event as shown in FIG. 4I and FIG. 4J.

FIG. 4I shows current event sites pre-period overlapping with other events time periods, according to an exemplary embodiment. In some embodiments, the server initially determines the overlapping of entities by comparing the current event site 1 pre-period 424 with the first event site 1 post-period 428, and the current event site 2 pre-period 430 with the first event site 2 post-period 432.

For each entity in the current event, the server determines if the same entity is in the first event. If the entity of the current event is found in the first event, the server determines if there is overlap between the dates. The server determines that the dates overlap when the current event pre-period end date is greater than or equal to first event post-period start date, and the first event post-period end date is greater than or equal to current event post-period start date. As shown in the example illustrated of the FIG. 4I, the current event site 1 pre-period 424 overlaps with the first event site 1 post-period 428.

FIG. 4J shows current event sites post-period overlapping with other events time periods, according to an exemplary embodiment. In some embodiments, the server initially determines the overlapping of entities by comparing the current event site 1 post-period 434 with the first event site 1 post-period 428, and the current event site 2 post-period 436 with the first event site 2 post-period 432.

For each entity in the current event, the server determines if the same entity is in the first event. If the entity of the current event is found in the first event, the server determines if there is overlap between the dates. The server determines that the dates overlap when the current event post-period end date is greater than or equal to first event post-period start date, and the first event post-period end date is greater than or equal to current event post-period start date. As shown in the example illustrated of the FIG. 4J, the current event site 1 post-period 434 overlaps with the first event site 1 post-period 428. Thus, according to the determinations made by the server in the FIG. 4I and FIG. 4J, the site 1 of the current event overlaps with the first event.

In an embodiment, the server may adjust the overlapping, by either filtering any overlapping entities (e.g., site 1) from the analysis, or blacking out the dates that overlap. In another embodiment, the server upon identification of the overlap of site 1, may send a request to an administrator of the system to adjust for the overlapping activity. The administrator may adjust the overlapping by either filtering any overlapping entities (e.g., site 1) from the analysis, or blacking out the dates overlap from the analysis. A promotional forecast of future sales of the one or more items is then generated by the server that takes into account overlapping of the site 1 and may be decouples the data associated with the site 1 from the analysis.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method comprising:
receiving, by a server, a request to execute a first control strategy algorithm associated with a plurality of entities;
upon receiving the request, generating, by the server, a first instruction to a database to receive data associated with the first control strategy algorithm;
upon transmitting the first instruction, receiving by the server from the database, data associated with the first control strategy algorithm;
determining, by the server, a start date and an end date associated with a first pre-period and a first post-period associated with the first control strategy algorithm;
determining, by the server, a first range, wherein the first range comprises a minimum value associated with the first post-period and a maximum value associated with the first post-period;
determining, by the server, a first category of items, wherein the first category of items comprises a category of one or more items associated with the first control strategy algorithm;
generating, by the server, a second instruction to the database to receive a second control strategy algorithm associated with the plurality of entities;
upon transmitting the second instruction, receiving by the server from the database, data associated with the second control strategy algorithm;
determining, by the server, a start date and an end date associated with a second pre-period and a second post-period associated with the second control strategy algorithm;
determining, by the server, a second range, wherein the second range comprises a minimum value associated with the second post-period and a maximum value associated with second post-period;
determining, by the server, a second category of items, wherein the second category of items comprises a category of one or more items associated with the second control strategy algorithm; and
upon determining that the first category of items comprises items from the second category of items during a common period of the first range and the second range, dynamically adjusting, by the server, the first control strategy algorithm to exclude the processing of any entities that have the first category of items that comprises items from the second category of items during the common period of the first range and the second range; and
executing, by the server, the adjusted first control strategy algorithm.

2. The computer-implemented method of claim 1, further comprising upon determining that the first category of items comprises items from the second category of items during the common period of the first range and the second range, generating an instruction, by the server to the user interface, to display a notification associated with an overlapping of the first category of items with the second category of items.

3. The computer-implemented method of claim 1, wherein adjusting the first control strategy algorithm further comprises one or more of filtering common entities determined during the common period, or blacking out dates of common period.

4. The computer-implemented method of claim 1, wherein the first pre-period and the first post-period are time periods associated with the implementation of the first control strategy algorithm.

5. The computer-implemented method of claim 1, wherein the second pre-period and the second post-period are time periods associated with the implementation of the second control strategy algorithm.

6. The computer-implemented method of claim 1, further comprising identifying, by the server, one or more events that are active during a same time period at the entity.

7. The computer-implemented method of claim 6, wherein an event of the one or more events comprises at least one of: a price reduction, rewards for multiple purchases, loyalty card promotions, commercial advertisement, an e-mail offer, coupon promotions, rebate programs, or a natural disaster.

8. The computer-implemented method of claim 1, further comprising generating a baseline, by the server, by taking into account that the first category of items comprises items from the second category of items during the common period of the first range and the second range.

9. The computer-implemented method of claim 1, further comprising calculating, by the server, a lift value for the first category of items based on the adjusted first control strategy algorithm.

10. The computer-implemented method of claim 1, wherein the first pre-period and the second pre-period correspond to time-period leading up to execution of the first control strategy algorithm and the second control strategy algorithm respectively.

11. The computer-implemented method of claim 1, wherein the first post-period and the second post-period correspond to time-period during the execution of the first control strategy algorithm and the second control strategy algorithm respectively.

12. A computing system comprising:
one or more servers comprising one or more processors configured to:
receive a request to execute a first control strategy algorithm associated with an entity;
upon receiving the request, generate a first instruction to a database to receive data associated with the first control strategy algorithm;
upon transmitting the first instruction, receive from the database, data associated with the first control strategy algorithm;
determine a start date and an end date associated with a first pre-period and a first post-period associated with the first control strategy algorithm;
determine a first range, wherein the first range comprises a minimum value associated with the first post-period and a maximum value associated with the first post-period;
determine a first category of items, wherein the first category of items comprises a category of one or more items associated with the first control strategy algorithm;
generate a second instruction to the database to receive a second control strategy algorithm associated with the entity;
upon transmitting the second instruction, receive from the database, data associated with the second control strategy algorithm;
determine a start date and an end date associated with a second pre-period and a second post-period associated with the second control strategy algorithm;
determine a second range, wherein the second range comprises a minimum value associated with the second post-period and a maximum value associated with second post-period;
determine a second category of items, wherein the second category of items comprises a category of one or more items associated with the second control strategy algorithm;
upon determining that the first category of items comprises items from the second category of items during a common period of the first range and the second range, dynamically adjust the first control strategy algorithm to exclude the processing of any entities that have the first category of items that comprises items from the second category of items during the common period of the first range and the second range; and
execute the adjusted first control strategy algorithm.

13. The computing system according to claim 12, wherein the one or more servers comprising one or more processors are configured to, upon determining that the first category of items comprises items from the second category of items during the common period of the first range and the second range, generate an instruction to the user interface, to display a notification associated with an overlapping of the first category of items with the second category of items.

14. The computing system according to claim 12, wherein adjusting the first control strategy algorithm further comprises one or more of filtering common entities determined during the common period, or blacking out dates of common period.

15. The computing system according to claim 12, wherein the first pre-period and the first post-period are time periods associated with the implementation of the first control strategy algorithm.

16. The computing system according to claim 12, wherein the second pre-period and the second post-period are time periods associated with the implementation of the second control strategy algorithm.

17. The computing system according to claim 12, further comprising identifying, by the server, one or more events that are active during a same time period at the entity, wherein an event comprises at least one of: a price reduction, rewards for multiple purchases, loyalty card promotions, commercial advertisement, an e-mail offer, coupon promotions, rebate programs, or a natural disaster.

18. The computing system according to claim 12, further comprising generating a baseline, by the server, by taking into account that the first category of items comprises items from the second category of items during the common period of the first range and the second range.

19. The computing system according to claim 12, further comprising calculating, by the server, a lift value for the first category of items based on the adjusted first control strategy algorithm.

20. The computing system according to claim 12, wherein the first pre-period and the second pre-period correspond to time-period leading up to execution of the first control strategy algorithm and the second control strategy algorithm respectively, and wherein the first post-period and the second post-period correspond to time-period during the execution of the first control strategy algorithm and the second control strategy algorithm respectively.
